(19) United States
(12) Patent Application Publication
(10) Pub. No.: US 2009/0164089 A1
(43) Pub. Date: Jun. 25, 2009

(54) Method for operating an internal combustion engine

(76) Inventors: Mohamed Youssef, Nufringen (DE); Michael Kessler, Weissach (DE); Haris Hamedovic, Schwieberdingen (DE); Axel Loeffler, Backnang (DE); Peter Skala, Tamm (DE); Wolfgang Tiebel, Stuttgart (DE); Michael Scheidt, Stuttgart (DE); Andreas Rupp, Marbach (DE); Armin Woite, Stuttgart (DE)

Correspondence Address: KENYON & KENYON LLP, ONE BROADWAY, NEW YORK, NY, 10004, US

(21) Appl. No.: 12/291,950

(22) Filed: Nov. 14, 2008

(30) Foreign Application Priority Data
Dec. 19, 2007 (DE) 102007061100.7
Jun. 13, 2008 (DE) 102008002424.4

(51) Int. Cl. F02D 43/00

(52) U.S. Cl. 701/102; 701/115; 701/111

(57) ABSTRACT

A method for operating an internal combustion engine in which a combustion characteristic is ascertained. The combustion characteristic is ascertained in a cylinder-specific manner, and one or more application functions for the operation of the internal combustion engine is/are carried out as a function of the combustion characteristic.

### CROSS REFERENCE

This application claims the benefit under 35 U.S.C. §119 of German Patent Application No. DE 102007061100.7 filed on Dec. 19, 2007, and German Patent Application No. DE 102008002424.4 filed on Jun. 13, 2008, both of which are expressly incorporated herein by reference in their entirety.

### FIELD OF THE INVENTION

The present invention relates to a method for operating an internal combustion engine in which a combustion characteristic is ascertained.

The present invention also relates to a control device for an internal combustion engine of a motor vehicle and to a computer program for such a control device.

### BACKGROUND INFORMATION

Conventionally, the indicated torque of an internal combustion engine is ascertained and the internal combustion engine is controlled as a function thereof. The term indicated torque of an internal combustion engine refers to the torque that a loss-free internal combustion engine would be able to deliver. A torque from an actual internal combustion engine available, for example, for driving a motor vehicle therefore corresponds to the indicated torque less a torque representing the internal friction of the internal combustion engine, and possibly less other load torques that come from units driven by the internal combustion engine.

### SUMMARY

An object of the present invention is to improve a method of the type described above, as well as a corresponding control device and a computer program for a control device, to the end that more precise control of the internal combustion engine is possible.

According to an example embodiment of the present invention, this object may be achieved using the method of the type named at the outset by ascertaining the combustion characteristic for each cylinder individually and by carrying out one or more application functions for the operation of the internal combustion engine depending on the combustion characteristic.

The cylinder-specific ascertainment of the combustion characteristic allows particularly precise control of the internal combustion engine within the framework of the application functions according to the present invention. In particular, certain protective and monitoring functions which were only able to be implemented on the basis of other signals such as the lambda signal may advantageously also be efficiently implemented.

According to one specific embodiment of the present invention, the combustion characteristic may be ascertained depending on the signal from one or more cylinder pressure sensors. However, a different specific embodiment of the present invention is preferred, according to which the combustion characteristic is ascertained depending on a speed of the internal combustion engine, making it advantageously possible to forego the installation of separate cylinder pressure sensors.

It may be advantageous if an indicated torque or a combustion location or a maximum torque or a maximum gradient of a torque progression over an operational cycle of a cylinder is ascertained as the combustion characteristic. In this way it is possible to improve the control of the internal combustion engine and the protective and monitoring functions in terms of their precision and efficiency, particularly simply and with little expense.

According to a first particularly advantageous application function according to the present invention, the performance of a torque equalization regulation, in which the indicated torque of a plurality of cylinders of the internal combustion engine is set to the same value, is performed.

Detection of misfires in a cylinder-specific manner represents another application function according to the present invention which is made possible by ascertaining the combustion characteristic in a cylinder-specific manner. If the combustion characteristic is ascertained here depending on the speed of the internal combustion engine, the detection of misfires may be carried out reliably throughout the entire speed/load range of the internal combustion engine without using cylinder pressure sensors.

According to another particularly advantageous specific embodiment of the operating method according to the present invention, an application function is provided in the form of a torque limitation in a cylinder-specific manner, which may be utilized advantageously, in particular in the case of positive injector drift behavior, i.e., an increase in the quantity of fuel injected while the activation time remains constant, in order to ensure proper functioning of the internal combustion engine.

Use according to the present invention of the combustion characteristic ascertained in a cylinder-specific manner for an application function for the purpose of detecting an unintended increase in the indicated torque constitutes another advantageous specific embodiment of the operating method according to the present invention.

In general, according to another advantageous variant of the present invention, mixture formation may also be influenced as a function of the indicated torque, for example in the sense of adapting the mean quantity.

The example method according to the present invention may be implemented in the form of a computer program that is capable of running on a computer or an arithmetic-logic unit of a control device and is suitable for executing the method. The computer program may be stored, for example, on an electronic storage medium, while the storage medium may be contained, for example, in the control device.

Additional features, application options and advantages of the present invention result from the following description of exemplary embodiments of the present invention, which are depicted in the figures. All described or depicted features, individually or in any combination, constitute the object of the present invention, regardless of their combination in the claims or their back-reference and regardless of their formulation or depiction in the description or figures.

### BRIEF DESCRIPTION OF THE DRAWINGS

FIG. 1 shows a schematic block diagram of an internal combustion engine for carrying out an example operating method according to the present invention.

FIG. 2 shows a functional diagram of a first specific embodiment of the operating method according to the present invention.

FIG. 3 shows a functional diagram of a second specific embodiment of the example operating method according to the present invention.

FIG. 4 shows a functional diagram of a third specific embodiment of the operating method according to the present invention.

FIG. 5 shows a functional diagram of a fourth specific embodiment of the operating method according to the present invention.

FIG. 6 shows a functional diagram of a fifth specific embodiment of the operating method according to the present invention.

### DETAILED DESCRIPTION OF EXAMPLE EMBODIMENTS

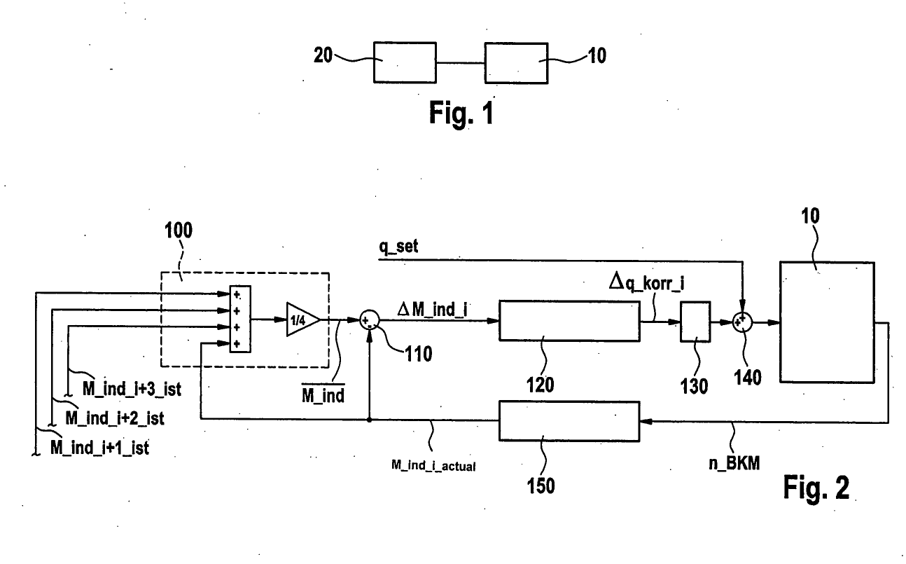

FIG. 1 shows a schematic block diagram of an internal combustion engine 10 of a motor vehicle. The operation of internal combustion engine 10 is controlled or regulated in a conventional manner by control device 20.

To that end, input values are supplied to control device 20. These input values are processed in control device 20 in accordance with data provided there, which results in control variables that are used to activate internal combustion engine 10 or actuators that control it.

The sequences of events required for operation of internal combustion engine 10 are coordinated in control device 20 for example by a computer program running on an arithmetic-logic unit, which is preferably stored in a non-volatile memory.

According to an example embodiment of the present invention, a combustion characteristic of internal combustion engine 10 is ascertained in a cylinder-specific manner, and one or more application functions for operating internal combustion engine 10 is/are carried out as a function of the combustion characteristic.

Although the ascertainment of the combustion characteristic in a cylinder-specific manner may also occur in principle using cylinder pressure sensors, ascertainment of the combustion characteristic is carried out according to the example embodiment of the present invention preferably solely as a function of the speed of internal combustion engine 10.

FIG. 2 shows a functional diagram of a first specific embodiment of the operating method according to the present invention, which implements an application function that corresponds to a torque equalization regulation between different cylinders of internal combustion engine 10.

By way of example, an internal combustion engine 10 with four cylinders is assumed here. Accordingly, a cylinder index i=1, . . . , 4 will be used for the description that follows.

In the following it is assumed by way of example and without limiting the generality that the indicated torque is ascertained in a cylinder-specific manner as the combustion characteristic.

First actual values M_ind_i_actual ascertained in a cylinder-specific manner for the indicated torque are supplied to averaging unit 100. Averaging unit 100 has an adder not further identified in FIG. 2, which adds together actual values M_ind_i_actual for the indicated torque. The thus obtained sum of the indicated torques of the four cylinders of internal combustion engine 10 is then divided by the number of cylinders, i.e., four in the present case, whereby a mean value M̅_̅i̅n̅d̅ for the indicated torque across all cylinders is obtained at the output of averaging unit 100.

Actual value M_ind_i_actual of the indicated torque for currently considered cylinder i of internal combustion engine 10 is subtracted from this mean value M̅_̅i̅n̅d̅ in adder 110, whereby a control deviation ΔM_ind_i is obtained at the output of adder 110. This control deviation ΔM_ind_i specifies the deviation of the actual value of the indicated torque for current cylinder i from actual value M̅_̅i̅n̅d̅ averaged across all cylinders i=1, . . . , 4 for the indicated torque.

Control deviation ΔM_ind_i is supplied to functional block 120, which represents a regulator and uses it to form a single-cylinder correction quantity Δq_korr_i for relevant cylinder i and makes it available at its output as shown in FIG. 2. Situated downstream from regulator 120 is a delay element 130, which delays output signal Δq_korr_i from regulator 120 by one operating cycle of internal combustion engine 10, so that output signal Δq_korr_i is available in the next operating cycle to correct a quantity of fuel to be injected for cylinder i.

The delayed correction quantity available at the output of delay element 130 is added in adder 140 to a driver-requested quantity q_set of fuel, and the thus obtained sum is finally supplied to internal combustion engine 10 or to appropriate actuators, for example injectors, which effect a corresponding injection of fuel for a future working cycle of internal combustion engine 10.

A resulting speed n_BKN of internal combustion engine 10 is supplied to signal processing unit 150, as shown in FIG. 2, which uses it to derive cylinder-specific indicated torque M_ind_i_actual, regarded according to the present invention. Finally, cylinder-specific indicated torque M_ind_i_actual obtained in this manner is supplied to averaging unit 100 and to adder 110.

According to an advantageous variant of the present invention, a target torque value which is derived from the driver-requested torque, which is formed, for example, as a function of an accelerator pedal position of a motor vehicle containing internal combustion engine 10, may also be used instead of mean value M̅_̅i̅n̅d̅ as the target value for regulator 120 or adder 110.

Because of the precise assignment of indicated torque M_ind_i_actual regarded according to the present invention to particular cylinder i, a particularly simple application of the operating method according to the present invention is advantageously possible. The application function according to the present invention described above with reference to FIG. 2 enables precise torque equalization regulation among the various cylinders i of internal combustion engine 10.

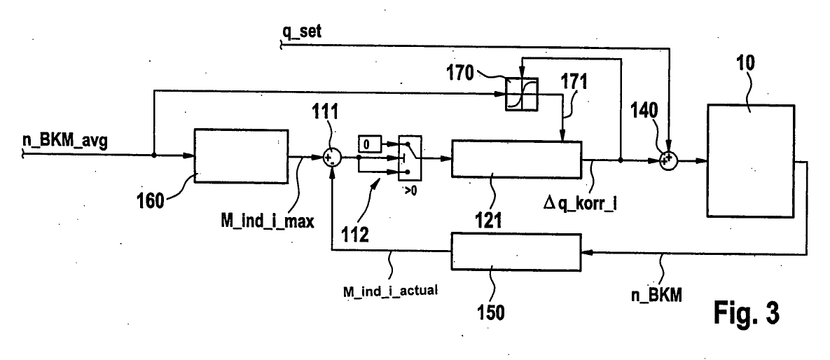

Another particularly advantageous application function for internal combustion engine 10, which corresponds to another specific embodiment of the operating method according to the present invention, is described below with reference to FIG. 3 and has a cylinder-specific torque limitation as its object.

In the case of this specific embodiment of the operating method according to the present invention, an indicated torque M_ind_i_actual individually ascertained for considered cylinder i is first obtained from a speed n_BKM of internal combustion engine 10 by the function block representing signal processing unit 150. Considered indicated torque M_ind_i_actual is supplied to adder 111, which subtracts this value from a predefinable maximum value M_ind_i_max for the cylinder-specific indicated torque. Maximum value M_ind_i_max is obtained in the present case, for example via a target value characteristic curve 160, to the input of which a mean speed n_BKM_avg of internal combustion engine 10 is supplied.

In function block 112, which is situated downstream from adder ill, a check is performed to determine whether cylinder-specific actual value M_ind_i_actual for cylinder i under consideration exceeds the maximum value M_ind_i_max specified by target value characteristic 160, or whether the difference M _ind_i_max−M_ind_i_actual is negative. If so, the difference obtained in adder 111 is supplied to the input of downstream regulator 121 as a control deviation, which in turn results in the formation of a cylinder-specific correction quantity Δq_korr_i in regulator 121.

Otherwise, i.e., if the actual value of indicated torque M_ind_i_actual is less than or equal to maximum value M_ind_i_max, the value 0 is supplied to the input of regulator 121 as a control deviation, which corresponds to the fact that if the actual value is less than maximum value M_ind_i_max for the indicated torque, no additional regulatory intervention is necessary to limit the torque.

As already described with reference to the exemplary embodiment according to FIG. 2, correction quantity Δq_korr_i made available at the output of regulator 121 is added by adder 140 to a driver-requested quantity q_set, and the resulting sum is used to activate internal combustion engine 10.

Analogously to the exemplary embodiment according to FIG. 2, the correction quantity Δq_korr_i provided by the output of regulator 121 may also be delayed initially by a delay element not depicted in FIG. 3 (see reference numeral 130 from FIG. 2) by one operating cycle of internal combustion engine 10, before it is supplied to adder 140 to activate internal combustion engine 10.

Regulator structure 112, 121 described above represents a self-overriding regulator, because a non-infinitesimal control deviation is only delivered if the maximum condition described above for the indicated torque is fulfilled.

Optionally, correction characteristic curve 170 depicted in FIG. 3 may additionally be used in order to learn the regulator intervention performed by regulator 121. In this case, the regulator intervention to be learned is stored in a rotational speed-dependent cylinder-specific correction characteristic curve, which may be used, for example, when starting internal combustion engine 10 to initialize regulator 121. One factor supplied to correction characteristic curve 170 for the learning process is correction quantity Δq_korr_i formed by regulator 121. Also supplied to correction characteristic curve 170 during normal operation is mean value n_BKM_avg of speed n_BKM of internal combustion engine 10, from which a corresponding initialization value is obtained with the aid of correction characteristic curve 170 for regulator 121 and supplied to the latter; see arrow 171 in FIG. 3.

Alternatively, learned correction characteristic curve 170 may be additively superimposed directly on a rotational speed-dependent quantity-limiting characteristic curve during normal operation of internal combustion engine 10; this is not depicted in FIG. 3. In this case it is possible to perform the limitation of torque or quantity according to the present invention with the help of the rotational speed-dependent quantity-limiting characteristic curve which may already be on hand and which is particularly advantageous if the limiting function according to the example embodiment of the present invention shown in FIG. 3 is temporarily unusable, for example due to inadequate signal quality of rotational speed sensor signal n_BKM.

This alternative use of correction characteristic curve 170 is also advisable if an injector drift that necessitates limiting the quantity or other effects that impair the metering of fuel develop so slowly that continuous activation of the function according to the example embodiment of the present invention as shown in FIG. 3 which is then necessary is unwanted, for example for reasons of resources.

The cylinder-specific torque limitation according to the present invention advantageously causes an increase in the operating life of internal combustion engine 10 without limiting its operation, because the components of the cylinder in question that might otherwise be overloaded are able to be protected specifically.

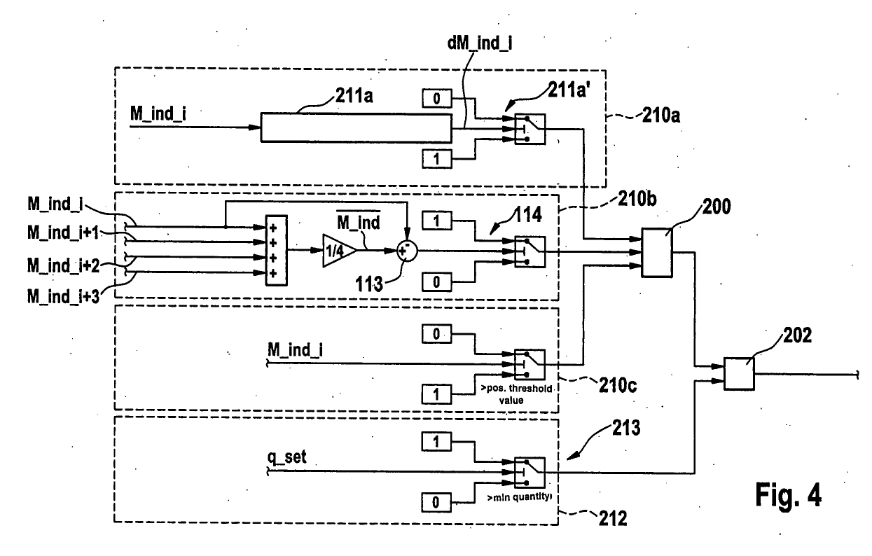

Another particularly advantageous exemplary embodiment of the operating method according to the present invention will be described below with reference to FIG. 4. The basis of the variant of the invention illustrated in FIG. 4 is an application function based on the indicated torque ascertained in a cylinder-specific manner, the object of which is to detect misfires.

In all, according to FIG. 4 three different functional branches 210a, 210b, 210c are provided, each of which delivers a logical output signal that is supplied to the input of central OR element 200. A value of logical “1” for the output signal in question indicates here that the particular functional branch has undertaken an evaluation of the input data supplied thereto, leading to the conclusion that a misfire of internal combustion engine 10 has occurred. Due to the OR operation through OR element 200, functional branches 210a, 210b, 210c are able to signal detection of the misfire even if only a single function block 210a, 210b, 210c indicates that a misfire has occurred.

An output signal formed accordingly by OR element 200 is supplied to downstream AND element 202, as shown in FIG. 4, which implements an AND operation with an additional function block 212.

Additional function block 212 receives as an input value driver-requested quantity q_set, and compares the latter in function block 213 to a predefinable minimum value. If driver-requested quantity q_set is less than the predefinable minimum quantity, the output signal from function block 212 has a value of logical “0,” and the output signal from AND element 202, which indicates a misfire detected according to the present invention, thus also has the value of logical 0. This means that the criteria implemented by various function blocks 210a, 210b, 210c for detecting a misfire are only meaningful if at the same time driver-requested quantity q_set is also greater than the predefinable minimum quantity. In that case function block 212 issues the value of logical “1” to AND element 202. Otherwise no misfire is detected.

As an alternative to the configuration depicted in FIG. 4, only a single or two or even more of function blocks 210a, 210b, 210c may be provided.

The functioning of individual function blocks 210a, 210b, 210c is described below with reference to FIG. 4.

First function block 210a receives as an input signal indicated torque M_ind_i, considered according to the present invention, for a considered cylinder i of internal combustion engine 10.

Indicated torque M_ind_i is supplied according to the present invention to a differentiating filter 211a, which delivers accordingly as its output value a differentiated indicated torque dM_ind_i, which is checked in subsequent function block 211a′ whether it is greater than a predefinable negative threshold value. If output signal dM_ind_i from differentiating filter 211a is less than the threshold value, i.e., if currently observed value M_ind_i is thus significantly less than corresponding torque values of prior operating cycles, function block 210a issues the value of logical 1 to signal a misfire. This output signal is supplied first to central OR element 200, as already described. If the evaluation in function block 212, as already described, shows that driver-requested quantity q_set is greater than the predefinable minimum quantity, with consideration for the value of logical 1 from function block 210a, the conclusion is finally drawn with the aid of logic elements 200, 202 that a misfire has actually occurred in cylinder i.

If the check in function block 210a by function flock 211a′ shows that differentiated indicated torque dM_ind_i is not less than the predefinable threshold value, i.e., that no significant reduction of the indicated torque is occurring in comparison to previous operating cycles, function block 210a issues the value of logical 0 to indicate that according to its evaluation there are no indications of a misfire.

Additional function block 210b first provides an averaging of indicated torques M_ind_i assigned to individual cylinders i, described earlier with reference to the exemplary embodiment according to FIG. 2. The averaging is also described in connection with the exemplary embodiment according to FIG. 4 on the basis of an internal combustion engine 10 having four cylinders.

Using adder 113, indicated torque M_ind_i of currently considered cylinder i is subtracted from mean value M̅_̅i̅n̅d̅. The resulting difference, i.e., the deviation between cylinder i and corresponding mean value M̅_̅i̅n̅d̅ in relation to the indicated torque, is supplied to downstream comparator logic unit 114, which checks the difference to determine if it is below a predefinable threshold that may possibly be selected depending on an operating point. If the difference is below the predefinable threshold, the output signal of function block 210b is set to the value of logical 0, because it may then be assumed that no misfire has occurred. However, if the difference exceeds the predefinable threshold, i.e., if currently considered torque M_ind_i_actual is significantly less than mean value M̅_̅i̅n̅d̅, according to the present invention the output signal of function block 210b is set to the value of logical 1 to indicate that a misfire has been detected.

Third function block 210c, whose output acts on central OR element 200, receives indicated torque M_ind_i of currently considered cylinder i of internal combustion engine 10 as an input variable. Function block 210c compares indicated torque M_ind_i to a predefinable positive threshold value, which may optionally also be operating point-dependent. If indicated torque M_ind_i is below this threshold value, the output signal of function block 210c assumes the value of logical 1 and thereby signals detection of a misfire. However, if indicated torque M_ind_i exceeds the threshold value, the output signal of function block 210c assumes the value of logical 0. Accordingly, the evaluation of function block 210c implements a plausibility check of the absolute amount of indicated torque M_ind_i for a particular cylinder i.

In summary, AND element 202 accordingly indicates a signal with the value of logical 1, which corresponds to a detected misfire, if at least one of previous function blocks 210a, 210b, 210c signals a misfire, and if at the same time driver-requested quantity q_set exceeds a predefinable threshold value, which is checked by function block 212, as already described.

Due to the previously described function blocks of the exemplary embodiment according to FIG. 4, it is possible using indicated torques M_ind_i ascertained in a cylinder-specific manner to achieve very precise detection of misfires of internal combustion engine 10, the misfire being assigned to the appropriate cylinder and thus simplifying a workshop analysis in particular.

In the exemplary embodiment according to FIG. 4, instead of the combustion characteristic of the indicated torque, it is also possible to ascertain the combustion characteristic of the combustion location or of the maximum torque or of a maximum gradient of a torque progression, preferably a differential gas torque progression, over an operational cycle of a cylinder in a cylinder-specific manner, and to use it in the described manner to detect a misfire for an individual cylinder. The combustion characteristic used in each case may be ascertained here in a cylinder-specific manner described in, for example, German Patent Application No. DE 10 2006 056 708 A1, from speed n_BKM of the internal combustion engine or from the cylinder pressure. The maximum torque here represents the absolute maximum of the preferably filtered differential gas torque progression for this cylinder over time or over the crankshaft angle, determined over one operating cycle of a cylinder. The evaluation of the misfire occurs here in exactly the same way as for the indicated torque, with the threshold values naturally adjusted appropriately. The maximum gradient of the preferably filtered differential gas torque progression represents the absolute maximum of this gradient for this cylinder over time or over the crankshaft angle, ascertained over one operating cycle of a cylinder. The evaluation of the misfire occurs here in exactly the same way as for the indicated torque, with the threshold values naturally adjusted appropriately.

All three function blocks 210a, 210b, 210c may also be evaluated in the manner described for evaluating the indicated torque to choose the combustion location as the combustion characteristic for detecting misfires, using appropriately adjusted threshold values. The combustion location is defined in this case for example as the crankshaft angle at which a predefined portion of the entire quantity of heat, for example 50%, is converted during combustion of the gas/air mixture in the particular cylinder. For the combustion location as well, its gradient may be evaluated in a cylinder-specific manner in a manner analogous to that described for the indicated torque in function block 210a. The combustion location for the individual cylinders relative to a mean combustion location may be evaluated in a manner analogous to that described for the indicated torque in function block 210b. The absolute combustion location for the individual cylinders may be evaluated in a manner analogous to that described for the indicated torque in function block 210c.

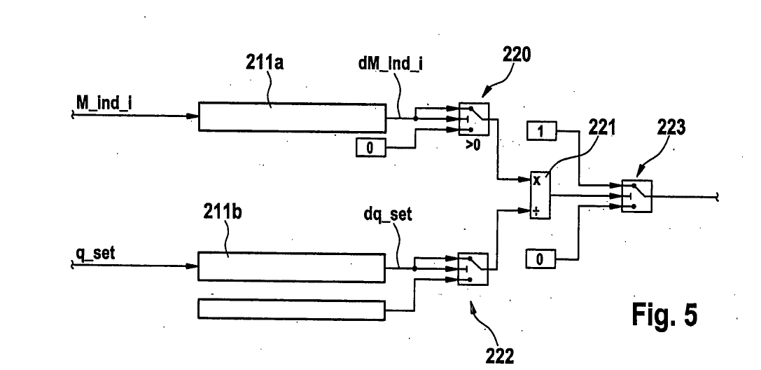

FIG. 5 shows an additional specific embodiment of the operating method according to the present invention, in which the object of the application function according to the present invention is to detect an unintended increase in indicated torque M_ind_i.

To this end indicated torque M_ind_i is supplied to a differentiating filter 211a, which provides at its output—as described earlier with reference to FIG. 4—a differentiated indicated torque dM_ind_i. A function block 220 situated downstream from differentiating filter 211a checks whether differentiated indicated torque dM_ind_i is negative, and whether currently considered value M_ind_i is accordingly less than corresponding torque values from previous operating cycles. If differentiated indicated torque dM_ind_i was detected in function block 220 as non-negative, it is supplied to downstream computing unit 221. Otherwise, i.e., if the differentiated indicated torque dM_ind_i is negative, the value of 0 is supplied to computing unit 221.

An additional input value of the functional diagram depicted in FIG. 5 is driver-requested quantity q_set, which is filtered through differentiating filter 211b, with the result that differentiated driver-requested value dq_set is obtained at the output of differentiating filter 211b. A comparator logic unit 222 situated downstream from differentiating filter 211b subsequently checks whether differentiated driver-requested quantity dq_set is greater than a predefinable minimum quantitative difference. If that is the case, differentiated driver-requested quantity dq_set is output by comparator logic unit 222 to computing unit 221. Otherwise comparator logic unit 222 forwards the value of the minimum quantitative difference to computing unit 221.

Computing unit 221 now forms an output value from the output values of comparator logic units 220, 222 supplied thereto; in the present case a quotient is formed for this purpose from the output value of comparator logic unit 220 and the output value of comparator logic unit 222. Comparator logic unit 223, situated downstream from computing unit 221, subsequently checks whether the quotient formed by computing unit 221 exceeds a predefinable threshold value. If this is the case, according to the example embodiment of the present invention, the conclusion is drawn that an unintended increase of indicated torque M_ind_i has occurred, and a logical output signal with the corresponding value of logical 1 is issued by comparator logic unit 223.

However, if the quotient formed by computing unit 221 does not exceed the predefinable threshold value according to comparator logic unit 223, according to the present invention the conclusion is drawn that no unintended increase of indicated torque M_ind_i has occurred, and the value of logical 0 is issued by comparator logic unit 223.

Detection according to the example embodiment of the present invention of an unintended increase of the indicated torque is accordingly based on the consideration that such an unintended increase is probable if differentiated indicated torque dM_ind_i is positive, and accordingly an increase of the indicated torque is apparent in relation to preceding operating cycles, while at the same time in addition an unusual, for example significantly smaller, time change in driver-requested quantity q_set appears.

The detection in a cylinder-specific manner of an unintended increase of the indicated torque made possible by the example embodiment of the present invention also simplifies the workshop diagnosis in particular.

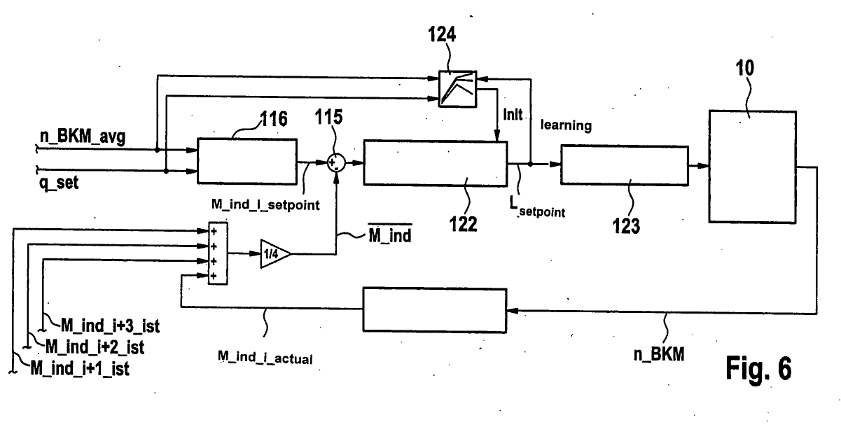

FIG. 6 shows a functional diagram of another specific embodiment of the operating method according to the present invention, in which the object of the application function according to the present invention is to influence a formation of a mixture for the operation of internal combustion engine 10 in the sense of adaptation of a mean quantity.

In the case of this specific embodiment as well—taking an internal combustion engine 10 with four cylinders as the basis—a mean value M̅_̅i̅n̅d̅ is first formed from indicated torques M_ind_i assigned to the various cylinders, the mean value being subtracted by adder 115 from a target value M_ind_setpoint, which is formed from a corresponding characteristics map 116 as a function of an average rotational speed n_BKM_avg and driver-requested quantity q_set.

The control deviation determined by adder 115 is supplied to downstream regulator 122, which uses it to form a correction value Lₛₑₜₚₒᵢₙₜ, which is usable to correct at least one control variable of the air system of internal combustion engine 10. Accordingly, value Lₛₑₜₚₒᵢₙₜ is supplied to downstream air system regular 123, which uses it to find, for example, a control variable for an exhaust gas return of a throttle valve or the like, which is finally suitable for activating internal combustion engine 10 in the manner depicted in FIG. 6.

Optionally, control variable Lₛₑₜₚₒᵢₙₜ may also be supplied to a correction characteristics map 124, which is usable for initializing regulator 122 efficiently. Correction characteristics map 124 ascertains appropriate initialization values for regulator 122 from parameters n_BKM_avg, q_set supplied to its input.

The specific embodiment of the operating method according to the present invention described above implements a regulator intervention into the air system control variables of internal combustion engine 10 in order to produce a desired air-fuel ratio.

As an alternative to the intervention into target air mass Lₛₑₜₚₒᵢₙₜ, it is also possible, for example, to modify driver-requested quantity q_set directly as a function of the control deviation formed by adder 115.

The specific embodiment of the operating method according to the present invention described above accordingly implements a mean quantity adaptation with which a desired air-fuel ratio is able to be regulated. However, in contrast to the specific embodiment of the present invention described with reference to FIG. 3, correction characteristics map 124 according to FIG. 6 has no characteristic curves for individual cylinders, but rather depends solely on the input values n_BKM_avg, q_set.

A combination of the application functions according to the present invention is also possible.

What is claimed is:

1. A method for operating an internal combustion engine, comprising:
ascertaining a combustion characteristic in a cylinder-specific manner; and
performing one or more application functions for operating the internal combustion engine depending on the combustion characteristic.

2. The method as recited in claim 1, wherein the combustion characteristic is ascertained one of i) as a function of a speed of the internal combustion engine, or ii) as a function of a signal from one or more cylinder pressure sensors.

3. The method as recited in claim 1, wherein one of: i) an indicated torque, ii) a combustion location, iii) a maximum torque, or iv) a maximum gradient of a torque progression over an operational cycle of a cylinder, is ascertained as a combustion characteristic.

4. The method as recited in claim 1, wherein the one or more application functions includes a torque equalization regulation, the torque equalization regulation setting an indicated torque of a plurality of cylinders of the internal combustion engine to the same value.

5. The method as recited in claim 1, wherein the one or more application functions includes a detection of misfires.

6. The method as recited in claim 1, wherein the one or more application functions includes a limitation of torque in a cylinder-specific manner.

7. The method as recited in claim 1, wherein the one or more application functions includes detection of an unintended increase of the indicated torque.

8. The method as recited in claim 1, wherein the one or more application functions includes influencing a mixture as a function of the indicated torque.

9. A memory medium storing a computer program, the computer program, when executed by a control device, causing the control device to perform the steps of:
ascertaining a combustion characteristic in a cylinder-specific manner; and
performing one or more application functions for operating an internal combustion engine depending on the combustion characteristic.

10. A control device for an internal combustion engine of a motor vehicle, the control device adapted to ascertain a combustion characteristic in a cylinder-specific manner, and carrying out one or more application functions for operating the internal combustion engine depending on the combustion characteristics.
